(19) United States
(12) Patent Application Publication
(10) Pub. No.: US 2015/0196046 A1
(43) Pub. Date: Jul. 16, 2015

(54) Animal Feed Composition

(71) Applicants: John Lee, Olathe, KS (US); David Bloor, New Plymouth (NZ)

(72) Inventors: John Lee, Olathe, KS (US); David Bloor, New Plymouth (NZ)

(73) Assignees: LOWE CORPORATION LIMITED, Hastings (NZ); RIGEL TECHNOLOGY CORPORATION, Olathe, KS (US)

(21) Appl. No.: 14/446,692

(22) Filed: Jul. 30, 2014

(30) Foreign Application Priority Data
Jan. 14, 2014 (NZ) 619959

(51) Int. Cl. A23K 1/00; A23K 1/08; A23K 1/10; C02F 11/14; A23K 1/18

(52) U.S. Cl. CPC A23K 1/001; C02F 11/14; A23K 1/1813; A23K 1/1853; A23K 1/106; A23K 1/08; C02F 2103/32

(57) ABSTRACT

A novel and practical process to convert the oily sludge from food industry and waste water treatment into a non-oily feed product in dry and free-flowing form for animal applications is provided. The combination of an alkaline agent to encapsulate the oily sludge into a non-oily form and a particulate material to provide solid surface as a carrier is used to convert the oily sludge into a non-oily wet paste or particle form. Then a drying process with a commercial dryer is applied for producing an animal feed product in non-oily, dry and free-flowing form. The animal feed product retains a fat level, which is generally higher than normal animal feed products, but in an easily handled, non-oily, non-sticky, free-flowing and dry form. The process of the invention converts the problematic food waste sludge with oily, sticky and wet properties into the useful nutritional products with the improved properties. The process in the present invention is practical and economical to be used, which could resolve the problem from these oily sludge materials, save and create millions of dollars for food and feed industries and waste water treatment plants.

### REFERENCE CITED

U.S. Patent Documents

| | | |
|---|---|---|
| U.S. Pat. No. 5,958,241 | Sep. 28, 1999 | DeBenedetto et al. |
| U.S. Pat. No. 6,368,657 | Apr. 9, 2002 | Lee |
| U.S. Pat. No. 6,464,875 | Oct. 15, 2002 | Woodruff |
| U.S. Pat. No. 6,805,897 | Oct. 19, 2004 | Rounds et al. |
| U.S. Pat. No. 7,446,215 | Nov. 4, 2008 | Lee |
| U.S. Pat. No. 8,003,833 | Aug. 23, 2011 | Appel et al. |
| U.S. Pat. No. 8,197,680 | Jun. 12, 2012 | Sharir |
| U.S. Pat. No. 8,677,647 | Mar. 25, 2014 | Weiseelberg |

Foreign Patent Documents

| | | |
|---|---|---|
| AU Patent Application 200327855 | Oct. 5, 2003 | Cronin |
| NZ Patent 504619 | Oct. 6, 2003 | Degremont |
| WO 2007/012129 | Feb. 1, 2007 | Scott |
| AU Patent Application 2008243273 | Nov. 17, 2008 | Skudder |

### TECHNICAL FIELD

The present invention relates to a process of treating oily sludge from waste water generated from the food industry. The process of the invention converts the oily sludge into non-oily value-added products for use as animal feeds.

### BACKGROUND ART

Food processing plants produce food products such as meat, poultry, fish, milk, cheese, ice cream, vegetable oil, grease, grain, gelatine and others. In doing so, large volumes of waste water are produced. Waste water is characterised in terms of its physical, chemical and biological constituents, which are defined by parameters such as the water's BOD (biological oxygen demand), COD (chemical oxygen demand), FOG (fats, oils and grease), SS (suspended solids) and TKN (total Kjeldahl nitrogen). Waste water process generally seeks to reduce the levels of one or more of these parameters.

Dissolved air flotation (DAF) systems, which are commonly used, do this by injecting air bubbles into the wastewater. Insoluble particles adhere to the air bubbles, rise to the surface, and can be mechanically scrapped off in the form of a liquid sludge (DAF sludge). Polymers are often used in DAF systems to bind more organic matter. Simple floatation systems also produce oily sludge.

Oily sludge is rich in nutrients. It mainly comprises fats and proteins in waste water. Although it usually has moisture content of 60-85%, the DAF sludge from an animal processing plant may contain about 80-100% nutrients on a solid basis.

Disposal is problematic. Oily sludge generally comprises 15 to 90% of fat on a solids basis, of which 20 to 85% are usually free fatty acids. Free water can be removed by pressing, filtration, setting or decant to give moisture levels of about 35-75%. However, oily sludge is oily and sticky and cannot be dried using normal heat drying processes because of its high lipid content, which causes it to liquefy when heated.

Typical methods for disposing of oily sludge involve burying it and/or using microorganisms to digest the organic matter present. Neither process is environmentally desirable. Both waste the potential nutritional value of the materials.

Other methods include separating the components into lipid, waste water and solid phases by heat and centrifugation, but the process is expensive relative to the value of the resulting components, which remain somewhat contaminated by the other components.

DAF sludge is sometimes pumped into a large lagoon, which is only a temporary solution. The fats, oils and grease float to the top of the lagoon while the bottom layer of waste water is processed by biological methods. However, the oily sludge comprising the top layer needs further processing.

Accordingly, it is an object of the present invention to go some way to avoiding the above disadvantages; and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

Over the years, various attempts have been made to treat or use these oily sludge materials from food industry and waste water treatment. There are a number of patents or patent applications for these attempts.

U.S. Pat. No. 8,677,647 discloses an apparatus and method for treatment of biosolid materials in nature of sewage of sludge with the elimination of or reduced levels of pathogens. U.S. Pat. No. 8,197,680 discloses an apparatus for waste water sludge dewatering apparatus includes an inflatable membrane to press solids against a screen and thereby separate liquid and nozzles to wash the screen of the separated solids. U.S. Pat. No. 8,003,833 discloses a process to convert organic, waste or low-value materials into useable products including gas, oil and carbon solids with high heat and pressure.

AU Patent Application No. 2008243273 discloses a method and apparatus for preparing organic material for microbiological fermentations of municipal waste water sludge for reducing the wastewater sludge and/or of cellulosic material. WO 2007/012129 (AU 2006/001054) discloses a method of producing a product comprising a mixture of a grain material and DAF sludge, which is extruded under high temperature and pressure and at a pH of at least 6.2.

U.S. Pat. No. 7,446,215 discloses a method for preparing a solid fat product from some liquid fat or oil ingredients with a cooker by heating to above 85° C. to form a liquid form. Then a lime was added to react with the fat and cooled down to below 45° C. to form the solid fat product in dry form. U.S. Pat. No. 6,805,897 discloses a process to produce a feed supplement comprising DAF and paunch manure and an inert dry medium through an extrusion process.

U.S. Pat. No. 6,464,875 discloses a system and method for converting animal, vegetable and food byproduct materials into useful bio-gas and fertilizer using anaerobic digestion. After the digestion, there are still biosolid materials left, which need to be treated. U.S. Pat. No. 6,368,657 discloses a process to precipitate and encapsulate DAF skimming sludge by animal blood into a non-oily nutritional product with high protein and fat. U.S. Pat. No. 5,958,241 discloses waste treatment and minimization system including a bioreactor and a liquid/solid separator for treatment of organic plant wastes and associated waste water treatment processes.

AU Patent Application No. 200327855 discloses a method of using waste water sludge in the production of concrete. NZ Patent No. 504619 discloses a method for regulating centrifuges for dehydrating wastewater sludge, using fuzzy logic.

### SUMMARY OF THE INVENTION

In a first aspect the invention provides a process for preparing an animal feed product from oily sludge, the process comprising

(a) mixing the oily sludge with an alkaline agent,

(b) mixing a particulate material, and

(c) drying the encapsulated oily sludge to give a flowable and non-oily, animal feed product.

In one embodiment, the oily sludge comprises about 15 to 90% of fat on a solid basis, typically about 65%. In one embodiment, oily sludge comprises about 25 to 40% fat, preferably about 30% fat.

In one embodiment, the oily sludge is DAF sludge.

In one embodiment, the alkaline agent is selected from calcium hydroxide, calcium oxide or a mixture thereof. Preferably, the alkaline agent is calcium hydroxide. In one embodiment, 0.2 to 20% of alkaline agent is added, preferably 3 to 15%, based on the solid weight of the oily sludge. The major function of the alkaline agent is to encapsulate the oily sludge from oily form into non-oily form. Less calcium hydroxide or calcium oxide should be used to avoid or reduce protein to be reacted into ammonia hydroxide (NH₄OH) or ammonia (NH₃) after converting the oily into non-oily form.

The particulate material in particle or powder form comprises soybean meal, soy hulls, soybean protein derivatives, wheat, wheat straw wheat bran, corn meal, corn stalks, corn cobs, alfalfa, sweet bran, silage, oats, oat straw, barley, barley straw, meat meal, bone meal, animal blood meal, maize meal, maize derivatives, sunflower meal, sunflower hulls, cottonseed, cotton hulls, feed ingredients or mixtures thereof. Preferably, the particulate material comprises soybean meal, maize meal, meat meal, bone meal, animal blood meal or mixtures thereof. The major function of the particulate material is to provide solid surface as a carrier for the oily sludge or encapsulated oily sludge.

In a second aspect, the invention provides an animal feed product produced using the process of the invention.

In one embodiment, the animal feed product has a fat content of about 10 to 70% on a solids basis. In another embodiment, the animal feed product has a fat content of about 25 to 35%, preferably about 30%. The animal feed product has a protein content of about 30 to 55%, preferably about 40%.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

### DETAILED DESCRIPTION OF THE INVENTION

The process of the invention converts oily sludge from waste water treatment into a valuable, nutritional product, suitable for use as an animal feed. The oily sludge can be sourced from any type of plant or facility that produces it. Examples of oily sludge include DAF sludge, floatation sludge, lagoon sludge, biomass, any oily wet solid form or combinations of these. Typically, the oily sludge will originate from a food processing plant, for example, beef, poultry or pork but other sources are also suitable, such as dairy processing plants, gelatine factories and city waste water treatment facilities. Preferably, the oily sludge is DAF sludge.

In one embodiment, the oily sludge comprises about 15 to 90% of fat on a solid basis, typically about 65% on a solids basis. In one embodiment, oily sludge comprises about 25 to 40% fat, preferably about 30% fat.

A screen, press (such as belt or screw press), centrifugal (such as decant), filtration or combination of these may be used to reduce the moisture of the oily sludge prior to processing, to reduce processing costs.

In one embodiment the oily sludge originates from the processing of beef, poultry, fish, dairy or gelatine.

In one embodiment, the alkaline agent is selected from calcium hydroxide, calcium oxide or a mixture thereof. Preferably, the alkaline agent is calcium hydroxide. The alkaline agent should be of feed-grade.

In one embodiment, less than 20% of alkaline agent is added and preferably 3 to 15%, based on the solid weight of oily sludge. The alkaline agent must be well mixed with the oily sludge to produce a wet mass, typically in paste or particle form. In one embodiment, the alkaline agent and oily sludge are mixed at 10 to 250° C., preferably about 10 to 40° C.

A particulate material is mixed. The mixing order of the three raw materials is not important, in which the oily sludge is mixed with either the alkaline agent or particulate material at first or at the same time. After a drying process, a flowable and non-oily product is produced. The particulate material must be suitable for animal consumption and should comprise particles of a size suitable as a carrier to the oily sludge. In one embodiment, the particulate material comprises particles of a size such that 95% of the particles pass through such as a US10 sieve.

In one embodiment, about 10 to 70% of particulate material is added, based on the weight of total oily sludge. Preferably, 10 to 30% of particulate material is added, based on the weight of total oily sludge. After considering the oily sludge with moisture content about 60-85% (or solid content of 40-15%) and adjusting from wet weight into solid basis, the mixing rates of oily sludge, alkaline agent and particle material are at 100:<20:<250 and preferably about at 100:3-15:20-150 on a solid basis.

The particulate material can also confer additional nutritional benefits to the product. For example, particulate materials that are high in protein increase the protein content of the animal feed product of the invention.

In one embodiment, the particulate material comprises soybean meal, soy hulls, soybean protein derivatives, wheat, wheat straw wheat bran, corn meal, corn stalks, corn cobs, alfalfa, sweet bran, silage, oats, oat straw, barley, barley straw, meat meal, bone meal, animal blood meal, maize meal, maize derivatives, sunflower meal, sunflower hulls, cottonseed, cotton hulls, feed ingredients or mixtures thereof. Preferably, the particulate material comprises soybean meal, maize meal, meat meal, bone meal, animal blood meal or mixtures thereof

Once encapsulated by the alkaline agent and particulate material, the encapsulated DAF sludge material is dried to form a flowable and non-oily product, which is suitable for use as an animal feed. Drying can be carried out using any suitable means in the art, for example, a steam disc, gas fired, fluid bed, hot air, flash or drum dryer. The original oily sludge is oily, soft and sticky and very difficult to be dried directly with a commercial dryer because of the high fat content. If a mixture has low moisture such as less than 10%, drying may not be required.

In one embodiment, the animal feed product of the invention has moisture content of about less than 10%, preferably about 6 to 8%. The animal feed product of the invention may also be sterilised, using conventional methods known in the art. Anti-caking agents such as calcium phosphate, silica, clay, calcium carbonate etc may be used to increase flowability, usually added at 0.1 to 2%.

Typical animal feed stocks require added fat to boost energy levels. The animal feed product of the invention is naturally high in fat, requiring no augmentation to achieve a high energy density.

In one embodiment, the animal feed product of the invention has a fat content of about 10 to 35%. The animal feed product has a protein content of about 30 to 55%. The fat and protein content depends on the nature of the oily sludge and the particulate material used in the process.

The flowable, non-oily and non-sticky animal feed product of the invention is easily stored, transported and handled. It can be used as a feed for a wide range of livestock including cows, sheep, fish, pigs, goat, poultry, deer and the like. However, in some circumstances it may not be appropriate to feed to a particular animal, a product containing oily sludge or particulate material originating from that animal.

Where the particulate material is a grain meal such as soy meal, the animal feed product may be an effective bypass product for ruminants. It can also be used as a feed for companion animals such as cats and dogs.

### EXAMPLES

The following examples set forth preferred methods in accordance with the invention. It is to be understood, however, that these examples are provided by way of illustration and nothing therein should be taken as a limitation upon the overall scope of the invention.

### Example 1

The oily sludge from a dissolved air flotation (DAF) unit in a poultry processing plant was mixed with calcium hydroxide. Soybean meal was added and mixed. The mixing rates of the oily DAF sludge, calcium hydroxide and soybean meal were at about 100:14:50 on a solid basis. The mixture was in a wet particle form. Then the wet mixture was dried at about 100° C. to give a non-oily dry product in free-flowing particle form with moisture content of 6%.

### Example 2

The DAF sludge from a beef processing plant was mixed with calcium hydroxide and beef meat bone meal at room temperature. The mixing rates of the oily DAF sludge, calcium hydroxide and beef meat bone meal were at about 100:15:50 on a solid basis. The wet mixture was dried at about 100° C. into a non-oily dry product in free-flowing particle form.

### Example 3

The wastewater sludge from a dairy product processing plant was mixed with calcium oxide. Soybean meal was added. The rates of the mixture from the oily DAF sludge, calcium oxide and soybean meal were at about 100:10:50 on a solid basis. The wet mixture was dried into a non-oily dry product in free-flowing particle form.

### Example 4

The DAF sludge from an animal gelatine processing plant was filtered and pressed to remove free water and mixed with calcium oxide and corn meal at room temperature. The rates of the mixture from the oily DAF sludge, calcium oxide and corn meal were at 100:15:60 on a solid basis. The wet mixture was dried into a non-oily dry product in free-flowing particle form.

### Example 5

The oily DAF sludge from a beef processing plant was mixed with calcium hydroxide and beef meat bone meal at room temperature. The mixing rates of the oily DAF sludge, calcium hydroxide and meat bone meal were at 100:15:100 on a solid basis. The mixture was processed by a bowl cutter into a wet uniform particle form. Then the uniform mixture was dried with a flash hot air dryer into a non-oily dry product in free-flowing particle form. The product temperature was about 100° C. From the analysis tests, the product had protein 34.5%, fat 30.5%, ash 30.7%, calcium 10.3%, carbohydrates 3.0% and moisture 0.8%.

### Example 6

The pork decanter solid from a pork waste water process was mixed with calcium hydroxide and soybean meal at room temperature. The rates of the dairy decanter solid, calcium hydroxide and soybean meal at 100:12:60 on a solid basis. The mixture was mixed and cut into a wet particle form. Then the mixture was dried into a non-oily dry product in free-flowing particle form. The product temperature was about 110° C. The product had protein 38.7%, fat 14.9%, ash 14.8%, calcium 4.9% and moisture 7.2%.

### INDUSTRIAL APPLICABILITY

The invention provides a process for converting oily sludge from the waste water of food processing plants into a non-oily, flowable, dry feed product for animal use. The dry product retains nice fat levels but in an easily handled, non-oily, free-flowing form. This represents a significantly improvement over normal oily feed products with the same or similar fat levels.

In addition, the process of the invention converts a problematic waste material into a useful nutritional product, greatly benefiting the environment.

What is claimed is:

1. A method of processing for an animal feed product from oily sludge from food industry and waste water treatment, the process comprising (a) mixing the oily sludge with an alkaline agent, (b) mixing a particulate material and (c) drying the encapsulated oily sludge with a commercial dryer to give a flowable and non-oily animal feed product.

2. The method of claim 1 wherein the oily sludge comprises fat content at 15% to 90% and preferably 20% to 65% fat on a solid basis and solid content at more than 10% and preferably at more than 20% (or moisture at less than 90% and preferably at less than 80%) from food industry and waste water treatment.

3. The method of claim 1 wherein the alkaline agent is selected from calcium hydroxide, calcium oxide or their mixture thereof at less than 20% and preferably 3% to 15%, which is based on the solid of the oily sludge, to encapsulate the oily sludge into non-oily form.

4. The method of claim 1 wherein the particulate material in particle or powder form at less than 250% and preferably 20% to 150%, which is based on the solid of the oily sludge, comprises soybean meal, soy hulls, soybean protein derivatives, wheat, wheat straw wheat bran, corn meal, corn stalks, corn cobs, alfalfa, sweet bran, silage, oats, oat straw, barley, barley straw, meat meal, bone meal, animal blood meal, maize meal, maize derivatives, sunflower meal, sunflower hulls, cottonseed, cotton hulls, feed ingredients or mixtures thereof.

5. The method of claim 1 wherein mixing rates of the oily sludge, alkaline agent and particulate material are preferably at 100:3-15:20-150 on a solid basis.

6. The method of claim 1 wherein the mixture of the oily sludge, alkaline agent and particulate material in non-oily and wet paste or particle form is dried with a commercial dryer at a product temperature within 60-250° C. and preferably at 80-180° C. is used to evaporate and remove moisture into the animal feed product.

7. The method of claim 1 wherein the animal feed product in dry form has non-oily and flowable physical properties.

8. The method of claim 1 wherein the animal feed product is made according to the claim 1.

9. The method of claim 1 wherein the animal feed product is used for animal feed applications.
